(19) United States
(12) Patent Application Publication
(10) Pub. No.: US 2025/0196935 A1
(43) Pub. Date: Jun. 19, 2025

(54) Fastening Device for a Shell Element Which Is Flat at Least in Portions, and Frame Element for a Single-Track Motor Vehicle Having the Fastening Device

(71) Applicant: Bayerische Motoren Werke Aktiengesellschaft, Muenchen (DE)

(72) Inventor: Elmar JAEGER, Moosburg (DE)

(21) Appl. No.: 18/846,318

(22) PCT Filed: May 23, 2023
(86) PCT No.: PCT/EP2023/063718

§ 371 Date: Sep. 12, 2024

(30) Foreign Application Priority Data
Jun. 14, 2022 (DE) 10 2022 114 895.5

(51) Int. Cl. B62D 27/02; B62D 21/02; B62D 29/04

(52) U.S. Cl. CPC B62D 27/023; B62D 21/02; B62D 29/041

(57) ABSTRACT

A fastening device for a shell element which is flat at least in portions and which has a support element and a pressing element, wherein the pressing element is wedge-shaped and the support element is designed correspondingly to the wedge-shaped pressing element, wherein at least one fastener is provided, by way of which the pressing element is releasably fixed to the support element such that the shell element which is flat at least in portions is force-fittingly and form-fittingly fixable between the pressing element and the support element.

### BACKGROUND AND SUMMARY

This disclosure relates to a fastening device for a shell element which is planar at least in portions, having a support element and a compression element. Furthermore, the disclosure relates to a frame element for a single-track motor vehicle having the fastening device and a shell element which is planar at least in portions.

Forces have to be introduced into plastics-material parts, in particular CRP structural parts, over a large area. To this end, the solutions known in the prior art disclose the introduction of forces in a punctiform manner by way of thread inserts, inserts embedded by lamination, or non-releasable connections performed by adhesive bonding. However, metallic inserts which are embedded by lamination and adhesively bonded provide a non-releasable connection which, moreover, is not economical.

It is, therefore, an object of the present disclosure to provide a fastening device for a shell element, which enables forces to be introduced in a form-fitting manner over a large area, and is able to be disassembled.

PAccording to the disclosure, a fastening device for a shell element which is planar at least in portions, comprising a support element and a compression element, in which the compression element is wedge-shaped, and the support element is designed so as to correspond to the wedge-shaped compression element. Furthermore provided is at least one fastener by way of which the compression element is releasably fixed to the support element in such a manner that the shell element which is planar at least in portions is able to be fixed in a force-fitting and form-fitting manner between the compression element and the support element.

The support element, the compression element and the shell element to be fastened are in each case a structural component. By virtue of the fastener, the compression element in the assembled state generates a force acting on the shell element to be fastened, as a result of which the latter is able to be fixed in a force-fitting and form-fitting manner on the support element. The compression element herein is designed and sized in such a manner that the shell element is able to be clamped in a form-fit and a force-fit over a large area between the compression element and the support element. For this purpose, the compression element and the support element are wedge-shaped, this enabling a form-fit and a force-fit. In this way, an introduction of forces over a large area is enabled and a fastening which is able to be disassembled is provided.

In one advantageous variant of embodiment it is provided that the support element and the compression element are composed of a metallic material. In this way, the fastener and threads are in particular also composed of a metallic material. An integration of the fastening device in a functional module is optimized due to the stiffness or strength of these components, and the shell element to be fastened is able to be integrated into the functional module by way of the fastening device.

In one exemplary embodiment of the disclosure, the compression element comprises lateral faces that converge in a wedge-shaped manner, and a smooth/flat central face which is disposed between the lateral faces. It is advantageous herein that an introduction of force over a large area is improved.

Furthermore, an embodiment in which the compression element has in each case one cutout for the at least one fastening element is favorable. As a result, the corresponding fastener in an assembled state protrudes through the compression element and fixes as well as positions the compression element, for example by way of a beard or a protrusion. Fixing the fastening device is optimized in this way.

In one preferred variant of the embodiment it is provided according to the disclosure that the support element has in each case one receptacle for the at least one fastening element. Furthermore, the respective receptacle projects from the support element in the manner of a protrusion. The protrusion-type receptacle may also be referred to as a dome or a dome-shaped receptacle. The receptacle corresponds to the cutout of the compression element and/or a cutout of the shell element to be fastened, as a result of which settling is counteracted and the fastening is optimized.

In one variant of embodiment, the fastening device according to the disclosure is designed in such a way that reinforcement ribs are formed on the compression element. It is advantageous herein that an introduction of force into the fastening device is improved.

In a further advantageous variant it is provided that rib cutouts for receiving reinforcement ribs of the shell element are formed on the compression element. Integrating a shell element with reinforcement ribs is optimized as a result.

Moreover, an embodiment in which the reinforcement ribs are disposed adjacent to the rib cutouts and extend in the extension of the rib cutouts on the compression element is favorable. The introduction of force into the fastening device is further improved as a result.

Furthermore proposed according to the disclosure is a frame element for a single-tick motor vehicle having a fastening device according to the above disclosure and a shell element which is planar at least in portions, in which the shell element is fixed in a force-fitting and form-fitting manner between the wedge-shaped compression element and the support element that is designed to correspond to the wedge-shaped compression element.

It is advantageous herein that, by virtue of the fastener, the compression element generates a force acting on the shell element to be fastened, as a result of which the latter is fixed in a force-fitting and form-fitting manner to the support element. The compression element here is designed and sized in such a manner that the shell element is clamped in a form-fit and a force-fit over a large area between the compression element and the support element. To this end, the compression element and the support element have a wedge shape enabling the form-fit and force-fit. In this way, an introduction of force over a large area is enabled, and a fastening of the shell element to the frame element that can be disassembled is provided. The frame element is, for example, part of the frame, or is the frame, of the single-track motor vehicle.

In one advantageous exemplary embodiment of the disclosure, the shell element has in each case one shell cutout for the at least one fastener. As a result, the corresponding fastener protrudes through the compression element and the shell element, the fixing of the fastening device being optimized as a result.

In one preferred variant of embodiment it is provided according to the disclosure that the shell cutout is designed to correspond to the projecting receptacle of the support element. In particular, in the assembled state the receptacle is disposed within the shell cutout and designed to correspond to the cutout. Clamping of the fastening device takes place as a result, this counteracting settling.

Furthermore, an embodiment in which the shell element is fixed in a force-fitting and form-fitting manner at least by way of one of the lateral faces and the central face of the compression element is favorable. Optimal fastening of the shell element to the frame element by way of the fastening device is already guaranteed as a result, and integrating the shell element in the fastening device is simplified.

In one particularly advantageous variant, the shell element is composed of a plastics material, in particular of a carbon fiber-reinforced plastics material, furthermore is in particular produced by way of an injection-molding method. An introduction of forces into a plastics-material component over a large area, and a solution which is able to be disassembled, are provided in this way.

Furthermore, an embodiment in which the shell element is a cladding part, in particular for a rear frame, is favorable. Moreover, in one advantageous variant the support element is a crossmember. An introduction of forces into a plastics-material component over a large area, and a solution that is able to be disassembled, are particularly favorable for these components of a single-track motor vehicle.

The features disclosed above can be combined with one another in an arbitrary manner to the extent that this is technically feasible and the features are not contradictory.

### BRIEF DESCRIPTION OF THE DRAWINGS

Other advantageous refinements of the disclosure will be illustrated in a more detailed manner hereunder by way of the figures in conjunction with the description of the preferred embodiment of the disclosure.

FIG. 1 shows a sectional view of a fastening device for a shell element which is planar at least in portions;

FIG. 2 shows a sectional view of a frame element for a single-track motor vehicle having the fastening device and a shell element;

FIG. 3 shows a perspective view of the frame element for a single-track motor vehicle having the fastening device and the shell element; and,

FIG. 4 shows a further perspective view of the frame element for a single-track motor vehicle having the fastening device and the shell element.

The figures are exemplary and schematic. The same reference signs in the figures denote functionally and/or structurally identical features.

### DETAILED DESCRIPTION OF THE DRAWINGS

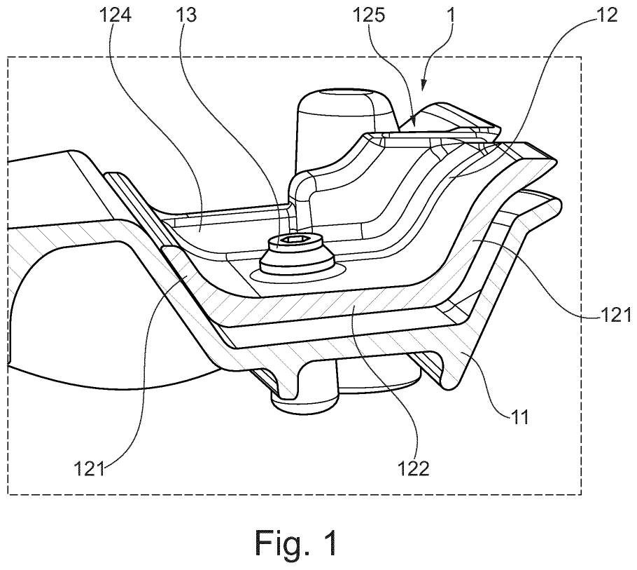

Illustrated in FIG. 1 is a sectional view of a fastening device 1 for a shell element 2, which is planar at least in portions, having a support element 11 and a compression element 12. The compression element 12 is wedge-shaped, and the support element 11 is designed to correspond to the wedge-shaped compression element 12. Furthermore provided is a fastener 13 by way of which the compression element 12 is releasably fixed to the support element 11 in such a manner that the shell element 2 which is planar at least in portions is able to be fixed in a force-fitting and form-fitting manner between the compression element 12 and the support element 11. The fastening element 13 is a screw which fixes the compression element 12 to a band. The support element 11 and the compression element 12 are composed of a metallic material.

The compression element 12 furthermore comprises lateral faces 121 that converge in a wedge-shaped manner, and a smooth/flat central face 122 which is disposed between the lateral faces 121. Moreover, reinforcement ribs 124 and rib cutouts 125 for receiving reinforcement ribs of the shell element 2 are formed on the compression element 12. The reinforcement ribs 124 here are disposed adjacent to the rib cutouts 125 and extend in the extension of the rib cutouts 125 on the compression element 12.

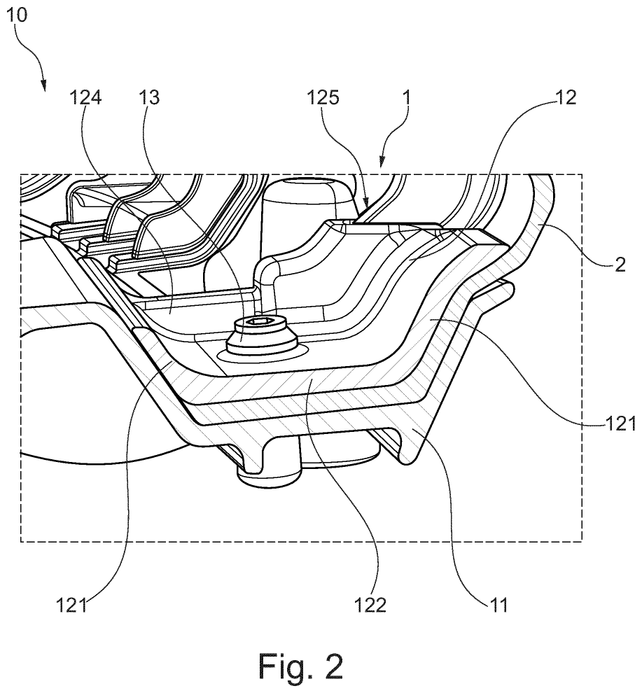

FIG. 2 shows a sectional view of a frame element 10 for a single-track motor vehicle having the fastening device 1 illustrated in FIG. 1 and a shell element 2. The shell element 2 is a cladding part for a rear frame of the single-track motor vehicle, and the support element 11 is a crossmember which connects the cladding part disposed on the left in a direction of travel to a lateral part, or cladding part, disposed on the right.

Furthermore, the shell element 2 is designed to be planar at least in portions, and is fixed in a force-fitting and form-fitting manner between the wedge-shaped compression element 12 and the support element 11 which is designed to correspond to the wedge-shaped compression element 12. Moreover, the shell element 2 has in each case one shell cutout 21 for the at least one fastener 13. The shell cutout 21 herein is designed to correspond to the projecting receptacle 111 of the support element 11. Furthermore, the shell element 2 is fixed in a force-fitting and form-fitting manner by way of one of the lateral faces 121 and the central face 122 of the compression element 12. The other lateral face 121 of the compression element 12 bears on a corresponding face of the support element. The shell element 2 is moreover composed of a carbon fiber-reinforced plastics material and is produced by way of an injection-molding method.

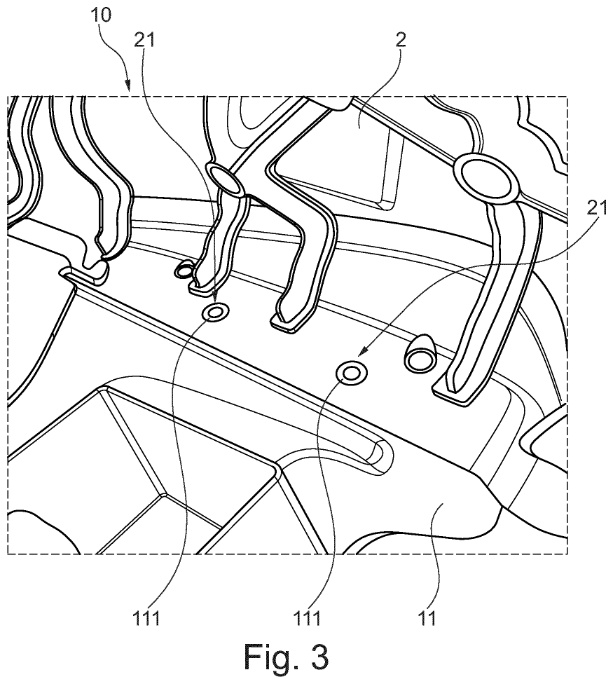

Illustrated in FIG. 3 is a perspective view of the frame element 10, shown in FIG. 2, for a single-track motor vehicle having the fastening device 1 and the shell element 2. However, the compression element 12 and the fastener 13 are not shown here. The support element 11 has in each case one receptacle 111 for the respective fastening element 13, and the respective receptacle 111 projects from the support element 11 in the manner of a protrusion. The shell cutout 21 herein is designed to correspond to the projecting receptacle 111 of the support element 11.

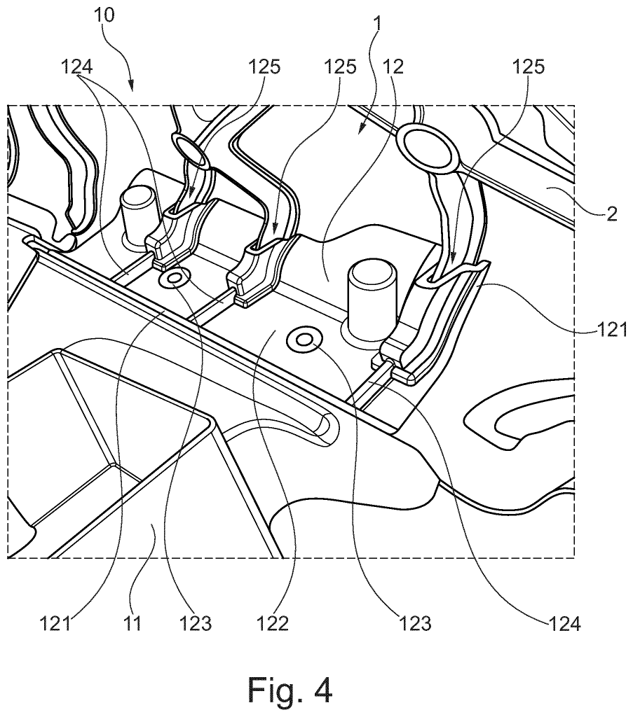

FIG. 4 shows a further perspective view of the frame element 10 for a single-track motor vehicle having the fastening device 1 without corresponding fastener 13 and the shell element 2. It is illustrated herein that the compression element 12 has in each case one cutout 123 for the respective fastening element 13.

The disclosure in terms of its embodiment is not limited to the preferred exemplary embodiments set forth above. Instead, a number of variants which utilize the solution illustrated even in fundamentally different embodiments are conceivable.

1.-15. (canceled)

16. A fastening device for a shell element which is planar at least in portions, the fastening device comprising:
a support element and a compression element, wherein the compression element is wedge-shaped, and the support element is designed so as to correspond to the wedge-shaped compression element, and
at least one fastener by way of which the compression element is releasably fixed to the support element in such a manner that the shell element which is planar at least in portions is able to be fixed in a force-fitting and form-fitting manner between the compression element and the support element.

17. The fastening device according to claim 16, wherein the support element and the compression element are composed of a metallic material.

18. The fastening device according to claim 16, wherein the compression element has lateral faces that converge in a wedge-shaped manner, and a smooth/flat central face which is disposed between the lateral faces.

19. The fastening device according to claim 16, wherein the compression element has in each case one cutout for the at least one fastening element.

20. The fastening device according to claim 16, wherein the support element has in each case one receptacle for the at least one fastening element, wherein the respective receptacle projects from the support element in the manner of a protrusion.

21. The fastening device according to claim 16, wherein reinforcement ribs are formed on the compression element.

22. The fastening device according to claim 16, wherein rib cutouts for receiving reinforcement ribs of the shell element are formed on the compression element.

23. The fastening device according to claim 21, wherein the reinforcement ribs are disposed adjacent to the rib cutouts and extend in the extension of the rib cutouts on the compression element.

24. A frame element for a single-track motor vehicle comprising:
a fastening device according to claim 16 and a shell element which is planar at least in portions,
wherein the shell element is fixed in a force-fitting and form-fitting manner between the wedge-shaped compression element and the support element that is designed to correspond to the wedge-shaped compression element.

25. The frame element according to claim 24, wherein the shell element has in each case one shell cutout for the at least one fastener.

26. The frame element according to claim 25 having a fastening device according to claim 20, wherein the shell cutout is designed to correspond to the projecting receptacle of the support element.

27. The frame element according to claim 24 having a fastening device according to claim 18, wherein the shell element is fixed in a force-fitting and form-fitting manner at least by way of one of the lateral faces and the central face of the compression element.

28. The frame element according to claim 24, wherein the shell element is composed of a carbon fiber-reinforced plastics material, by way of an injection-molding method.

29. The frame element according to claim 24, wherein the shell element is a cladding part for a rear frame.

30. The frame element according to claim 24, wherein the support element is a crossmember.
